(19) United States
(12) Patent Application Publication
(10) Pub. No.: US 2011/0015062 A1
(43) Pub. Date: Jan. 20, 2011

(54) COBALT/ZIRCONIUM-PHOSPHORUS/SILICA CATALYST FOR FISCHER-TROPSCH SYNTHESIS AND METHOD OF PREPARING THE SAME

(75) Inventors: Seung-Moon Kim, Daejeon (KR); Jong-Wook Bae, Daejeon (KR); Jong-Hyeok Oh, Daejeon (KR); Yun-Jo Lee, Daejeon (KR); Ki-won Jun, Daejeon (KR)

Correspondence Address: FROMMER LAWRENCE & HAUG, 745 FIFTH AVENUE- 10TH FL., NEW YORK, NY, 10151, US

(73) Assignee: Korea Research Institute of Chemical Technology, Daejeon (KR)

(21) Appl. No.: 12/933,856

(22) PCT Filed: Feb. 16, 2009
(86) PCT No.: PCT/KR2009/000734

§ 371 Date: Sep. 21, 2010

(30) Foreign Application Priority Data
Mar. 27, 2008 (KR) 10-2008-0028518

(51) Int. Cl. B01J 27/185

(52) U.S. Cl. 502/213

(57) ABSTRACT

The present invention relates to a cobalt/zirconium-phosphorus/silica catalyst in which cobalt, as an active ingredient, is impregnated on a zirconium-phosphorus/silica support prepared by treating the surface of silica with zirconium and phosphorus, and a method of preparing the catalyst. The catalyst has excellent reactivity since it has excellent heat and mass transfer properties due to a large pore structure of silica and increased reducibility of cobalt; excellent dispersion of cobalt and other activation substances during Fischer-Tropsch (F-T) reaction; and reduced sintering of cobalt particles during the reaction, and thus high CO conversion and stable selectivity for liquid hydrocarbon can be obtained during the F-T reaction.

### TECHNICAL FIELD

The present invention relates to a catalyst for Fischer-Tropsch (F-T) reaction, in which cobalt, as an active ingredient, is impregnated on a silica support including zirconium (Zr) and phosphorus (P), a method of preparing the same, and a method of preparing liquid hydrocarbons using a natural gas or a syngas resulting from gasification of coal or biomass in the presence of the catalyst.

### BACKGROUND ART

For Fischer-Tropsch (F-T) reaction, iron- and cobalt-based catalysts are used in general. Although the iron-based catalysts were preferred in the past for the F-T reaction, the cobalt-based catalysts have been predominantly used during the recent years in order to increase the production of liquid fuel or wax and to improve the catalyst performance. The iron-based catalysts are advantageous for the F-T reaction as they are the most inexpensive F-T reaction catalysts producing less methane at high temperature, and having high selectivity to olefins and the product can be utilized as a source material in chemical industry as light olefin or α-olefin, as well as fuel. In addition, many byproducts, including alcohols, aldehydes, ketones, etc., are produced in addition to hydrocarbons. Cobalt-based catalysts are expensive more than 200 times than Fe-based catalysts. However, cobalt-based catalysts show higher activity, longer lifetime, and higher yield of liquid paraffin-based hydrocarbon production with less CO₂ formation. However, they can be used only at low temperature because the excessive CH₄ is produced at high temperature. Furthermore, due to the usage of expensive cobalt, the catalysts are prepared by dispersing cobalt on a stable support with a large surface area, such as alumina, silica, titania, etc. A small amount of a precious metal such as Pt, Ru, Re, etc., is added thereto as a promoter.

A gas-to-liquid (GTL) process consists of three major sub-processes of reforming of natural gas, F-T synthesis of syngas, and hydrotreating of F-T product. The F-T reaction which is performed at a reaction temperature of 200 to 350° C. and a pressure of 10 to 30 atm using iron and cobalt as catalysts can be described by the following four key reactions.

(a) Chain growth in F-T synthesis

CO+2H_{2→}−CH₂−+H₂O ΔH(227° C.)=−165 kJ/mol

(b) Methanation

CO+3H_{2→}CH₄+H₂O ΔH(227° C.)=−215 kJ/mol

(c) Water gas shift reaction

CO+H₂O_{→}CO₂+H₂ΔH(227° C.)=−40 kJ/mol

(d) Boudouard reaction

2CO_{→}C+CO₂ΔH(227° C.)=−134 kJ/mol

A mechanism by which straight-chain hydrocarbons, as main products, are produced is mainly explained by Schulz-Flory polymerization kinetic mechanism. In the F-T process, more than 60% of the primary product has a boiling point higher than that of diesel oil. Thus, diesel oil can be produced by the following hydrocracking process and wax components can be transformed into high-quality lubricant base oil through a dewaxing process.

Typically, in order to disperse expensive active ingredients, cobalt and other activation ingredients are introduced to a support having a large surface area, such as alumina, silica, titania, etc., to prepare a catalyst. In particular, a catalyst prepared by dispersing cobalt, as an active ingredient, on a single-component or multi-component support is commercially utilized. However, if the particle size of cobalt included in the support is similar, the activity of the F-T reaction does not vary according to the type of the support [Applied Catalysis A 161 (1997) 59]. On the contrary, the activity of the F-T reaction is significantly influenced by the dispersibility and particle size of cobalt [Journal of American Chemical Society, 128 (2006) 3956]. Accordingly, a lot of attempts are being made to improve activity and stability of the F-T reaction by modifying properties of the support by pretreating the surface of the support with different additional metal components.

As another method of improving activity of the F-T catalyst, there is a method of improving stability of the catalyst by increasing diffusion rates of a compound having a high boiling point and produced during the F-T reaction, by preparing a silica-alumina catalyst having a bimodal pore-size structure [US Patent Application Publication No. 2005/0107479 A1; Applied Catalysis A 292 (2005) 252].

If silica is used as a support, reducing properties of cobalt may be decreased due to strong interaction between cobalt and the silica support, and thus activity of the catalyst may be decreased. The decrease in the degree of reduction and activity can be prevented by pretreating the surface of silica using metal such as zirconium [EP Patent No. EP 0167215 A2; Journal of Catalysis 185 (1999) 120]. The aforesaid F-T catalysts show various specific surface areas, but the activity of the F-T reaction is known to be closely related with the particle size of the cobalt component, pore size distribution of the support, and degree of reduction of the cobalt component. To improve these properties, a method of preparing a catalyst of the F-T reaction using a support prepared through a complicated process is reported.

### DISCLOSURE OF INVENTION

### Technical Problem

The present invention provides a catalyst for Fischer-Tropsch (F-T) reaction by which liquid hydrocarbons are prepared from a syngas, the catalyst having an enhanced activity, high selectivity for a compound having a high boiling point, improved dispersion and degree of reduction of cobalt as an active ingredient when a silica support having the surface treated with zirconium-phosphorus is used, and the enhanced stability since deactivation is prohibited by suppressing cobalt sintering during the reaction, when compared with a conventional cobalt/zirconium/silica catalyst, and a method of preparing the catalyst.

### TECHNICAL SOLUTION

According to an aspect of the present invention, there is provided a cobalt/zirconium-phosphorus/silica catalyst for F-T reaction in which cobalt, as an active ingredient, is impregnated on a support, wherein the support is a zirconium-phosphorus/silica support in which zirconium (Zr) and phosphorus (P) are simultaneously contained on the surface of porous silica having a specific surface area of 200 to 800 m²/g, wherein the amount of zirconium-phosphorus is in the range of 2 to 30 wt% relative to the silica, the amount of zirconium is in the range of 5 to 100 wt% relative to phosphorus, and the amount of cobalt (Co) is in the range of 10 to 40 wt% relative to the zirconium-phosphorus/silica support.

According to another aspect of the present invention, there is provided a method of preparing a cobalt/zirconium-phosphorus/silica catalyst for F-T reaction, the method including: preparing a zirconium (Zr)-phosphorus (P)/silica support by simultaneously containing a zirconium precursor and a phosphorus precursor on porous silica having a specific surface area of 200 to 800 m²/g, drying at a temperature of 100 to 200° C., and calcining at a temperature of 300 to 800° C.; and preparing a cobalt/zirconium-phosphorus/silica catalyst by supporting a cobalt precursor on the zirconium-phosphorus/silica support, drying at a temperature of 100 to 200° C., and calcining at a temperature of 100 to 700° C.

### BRIEF DESCRIPTION OF DRAWINGS

FIG. 1 illustrates the CO conversion with reaction time when F-T reaction is performed using catalysts prepared according to Example 2 and Comparative Example 1 to measure long-term stability of the catalysts.

FIG. 2 illustrates the yield of C5+liquid hydrocarbons, CO conversion, and selectivity for methane with different Zr/P weight ratio contained in a support when F-T reaction is performed using catalysts prepared according to Examples 1 to 3 and Comparative Examples 1 and 2.

FIG. 3 illustrates transmission electron microscopy (TEM) images of particles of cobalt in catalysts prepared according to Example 2 and Comparative Example 2 before and after F-T reaction.

### BEST MODE FOR CARRYING OUT THE INVENTION

Hereinafter, the present invention will be described more intensively with reference to the accompanying drawings, in which exemplary embodiments of the invention are shown.

The present invention provides a cobalt/zirconium-phosphorus/silica catalyst for F-T reaction in which cobalt, as an active ingredient, is impregnated on a zirconium-phosphorus/silica support in which zirconium (Zr) and phosphorus (P) are simultaneously contained on the surface of porous silica having a specific surface area of 200 to 800 m²/g.

The cobalt/zirconium-phosphorus/silica catalyst has a specific surface area of 190 to 300 m²/g, improved dispersion by modifying surface properties of silica by treating the silica with zirconium-phosphorus, reduced deactivation of the catalyst caused by aggregation (sintering) of cobalt during the reaction, and stable selectivity for liquid hydrocarbons (C₅ or more) due to improved degree of reduction of cobalt. Thus, the cobalt/zirconium-phosphorus/silica catalyst may be efficiently used for F-T reaction.

In the F-T reaction by which liquid hydrocarbons are prepared using a syngas, a catalyst is typically prepared using silica, alumina, titanium, etc., having a large surface area as a support, cobalt as an active ingredient, and a promoter in order to uniformly disperse the expensive active ingredient. However, if the surface of an alumina or titania support, among the supports having a strong affinity for phosphorous with a small surface area compared with silica, is treated with zirconium-phosphorus, the specific surface area of the support is reduced, thereby reducing the dispersion of cobalt, and thus the activity of the catalyst is not sufficiently increased.

A silica support has a uniform pore size of 10 to 20 nm, which is larger than that of alumina, and thus the reduction in specific surface area by the surface treatment using zirconium-phosphorus becomes relatively less. The specific surface area of the silica is also larger than that of titania, and thus the specific surface area by the surface treatment using zirconium-phosphorus becomes relatively less. Accordingly, the silica support may be efficiently used to support cobalt as an active ingredient and increase the dispersion of cobalt. In particular, if silica has a sufficiently developed porous structure, water generated during the F-T reaction is easily diffused through large pores, and thus deactivation of the catalyst caused by oxidation of cobalt may be reduced. In addition, since the surface properties of the support are modified by treating the surface of the support using zirconium-phosphorus, dispersion of cobalt may be improved, aggregation (sintering) of cobalt particles may be reduced, and thus deactivation of the catalyst may be inhibited to secure stable activity of F-T reaction.

The cobalt/zirconium-phosphorus/silica catalyst according to the present invention may include a zirconium-phosphorus/silica support prepared by introducing zirconium and phosphorus which is improving dispersion and the degree of reduction of cobalt on porous silica, and cobalt supported on the zirconium-phosphorus/silica support as an active ingredient.

That is, in the simultaneous treatment of the surface of silica using zirconium and phosphorus, the zirconium modifies the surface properties of the silica support to inhibit the possible transformation of cobalt into a cobalt silicate and a cobalt oxide, causing deactivation, and improve dispersion of cobalt, and the phosphorus could increase dispersion of zirconium on the surface of silica to produce stable zirconium phosphate, thereby reducing deactivation of the catalyst by inhibiting the sintering of the supported cobalt during the F-T reaction and reoxidation of cobalt by water generated during the F-T reaction.

The zirconium and phosphorus form a zirconium phosphate having a more stable structure compared with a conventional single metal such as zirconium, boron, alkaline earth metal, and lanthane to improve properties of the silica support. The zirconium phosphate may increase dispersion of cobalt, prevent the decrease in the degree of reduction of cobalt metal caused by strong interaction between the support and cobalt, and reduce the sintering of cobalt during the F-T reaction. Thus, silica support pretreated with the zirconium phosphate may be efficiently used for the production of liquid hydrocarbons from a syngas during the F-T reaction.

The silica may be any porous silica commonly used in the art having a specific surface area of 200 to 800 m²/g. If the specific surface area of silica is less than 200 m²/g, specific surface area of the catalyst is significantly decreased during the surface treatment using zirconium-phosphorus eventually to reduce dispersion of the active ingredient while cobalt is impregnated, thereby reducing the activity of F-T reaction. On the other hand, if the specific surface area of silica is greater than 800 m²/g, the particle size of cobalt increased on the outer surface of silica due to the small pore size, thereby reducing the activity of F-T reaction.

The amount of the zirconium-phosphorus may be in the range of 2 to 30 wt% relative to silica. If the amount of the zirconium-phosphorus is less than 2 wt%, the surface properties of the support cannot be sufficiently modified, and thus the activity of F-T reaction is not sufficiently increased. On the other hand, if the amount of the zirconium-phosphorus is greater than 30 wt%, the specific surface area of the support is abruptly reduced, and thus dispersion of cobalt is reduced. In addition, the amount of the zirconium may be in the range of from 5 to 100 wt% relative to phosphorus. If the amount of zirconium is less than 5 wt%, the specific surface area of the support is reduced due to the abundant presence of phosphorus and the degree of reduction of cobalt is decreased since cobalt phosphate is possibly formed, and thus the activity of F-T reaction may be reduced. On the other hand, if the amount of zirconium exceeds 100 wt%, the effect of phosphorus for modifying the surface of silica may be reduced and also the formation of a stable compound such as zirconium phosphate may be reduced. This will result in insufficient improvement of dispersion and degree of reduction of cobalt, insufficient inhibition of the sintering of cobalt particles, and may lead to rapid deactivation of the catalyst.

In addition, the cobalt/zirconium-phosphorus/silica catalyst may further comprise a promoter commonly used in the art, for example, Ru, Pt, and Rh. The amount of the promoter may be in the range of 0.05 to 2 wt% relative to the cobalt/zirconium-phosphorus/silica catalyst. If the amount of the catalyst promoter is less than 0.05 wt%, the effect of the catalyst promoter is negligible, and thus reducing properties of cobalt are not sufficiently increased and the activity of F-T reaction is not sufficiently increased. On the other hand, if the amount of the catalyst promoter is greater than 2 wt%, the economy of F-T process is not good with respect to the high cost for the catalyst promoter.

The present invention also provides a method of preparing a cobalt/zirconium-phosphorus/silica catalyst for Fischer-Tropsch reaction. In particular, a zirconium precursor and a phosphorus precursor are simultaneously impregnated on porous silica, and drying and calcination are performed to prepare a zirconium (Zr)-phosphorus (P)/silica support. Then, a cobalt precursor is impregnated on the zirconium-phosphorus/silica support, and drying and calcination are performed to prepare a cobalt/zirconium-phosphorus/silica catalyst.

The method of preparing the cobalt/zirconium-phosphorus/silica catalyst will be described in more detail.

First, the zirconium precursor and the phosphorus precursor are simultaneously impregnated on the porous silica, and drying and calcination are performed to prepare the zirconium(Zr)-phosphorus(P)/silica support. In this regard, the porous silica may have a specific surface area of 200 to 800 m²/g, and impurities and water contained in pores may be removed by calcining at a temperature of 300 to 800° C.

Any zirconium precursor that is commonly used in the art may be used without limitation. For example, the zirconium precursor may be a single compound selected from the group consisting of zirconium oxynitrate (ZrO(NO₃)₂.xH₂O), zirconium oxychloride (ZrOCl₂.xH₂O), zirconium sulfate (Zr(SO₄)₂), and zirconium chloride (ZrCl₄), or a mixture of at least two of these compounds. Any phosphorus precursor that is commonly used in the art may be used without limitation. For example, the phosphorus precursor may be a single compound selected from the group consisting of phosphoric acid (H₃PO₄), phosphorus oxychloride (POCl₃), phosphorus pentaoxide (P₂O₅), and phosphorus trichloride (PCl₃), or a mixture of at least two of these compounds.

The zirconium-phosphorus precursor may be supported using impregnation method, co-precipitation method, or the like, that is commonly used in the art, and the resultant is dried and subjected to calcination to prepare the zirconium-phosphorus/silica support. The drying may be performed at a temperature of 100 to 200° C. If the drying is performed at a temperature below 100° C., a solvent used during the preparation of the catalyst is not sufficiently evaporated from the pores of the support and zirconium-phosphorus is aggregated during the calcination of the catalyst, and thus dispersion may be reduced. On the other hand, if the drying is performed at higher than 200° C., rapid detachment of the solvent from the pores of the support may result in aggregation of zirconium-phosphorus on the outer surface of silica. The calcination is performed at a temperature of 300 to 800° C. If the calcination is performed at a temperature below 300° C., the surface of silica may not be sufficiently modified due to the remaining zirconium-phosphorus precursor, thereby suppressing the effects of the zirconium-phosphorus modification. On the other hand, if the temperature is higher than 800° C., pores of the support are blocked due to sintering, and thus the specific surface area of the support may be reduced.

Then, the cobalt precursor is impregnated on the zirconium-phosphorus/silica support, and the resultant is dried at a temperature of 100 to 200° C. and subjected to calcination at a temperature of 100 to 700° C., preferably 200 to 600° C. The cobalt precursor may be supported using a method commonly used in the art, for example, impregnation or co-precipitation method. In particular, the impregnation may be performed in an aqueous solution or an alcohol solution at a temperature of 40 to 90° C. The resulting materials is dried in an oven of 100° C. or higher for 24 hours, and then used as a catalyst. In addition, according to the co-precipitation, the cobalt precursor is co-precipitated on slurry-phase of zirconium-phosphorus/silica support in an aqueous solution at pH 7 to 8. After aging the resultant at 40 to 90° C., the precipitate is filtered and washed. The amount of cobalt is in the range of 10 to 40 wt% relative to the silica support treated with the zirconium-phosphorus. A basic precipitant is used in order to maintain the pH at between 7 and 8. Examples of the basic precipitant are sodium carbonate, potassium carbonate, ammonium carbonate, and ammonia water.

Such an impregnation and co-precipitation may also be applied to a method of supporting the zirconium-phosphorus precursor on the silica.

In addition, the aging of the catalyst may be performed for 0.1 to 10 hours, preferably for 0.5 to 8 hours, since the aging time in the recommended range is advantageous for the formation of a cobalt-containing F-T catalyst. If the aging time is less than 0.1 hour, dispersion of cobalt may be reduced, thereby decreasing the activity of F-T reaction. On the other hand, if the aging time is greater than 10 hours, the number of active sites may decrease due to the increased particle size of cobalt while the synthesis time may increase.

The cobalt/zirconium-phosphorus/silica catalyst prepared as described above is washed and dried. After the washing process, the product prepared according to the method described above may be dried in an oven at 100° C. or higher, particularly, at 100 to 200° C., for 24 to 48 hours. Then, the dried product may be directly used for the F-T reaction or may be used after supporting a precious metal catalyst component thereon and with or without a subsequent calcination step.

If the calcination temperature is less than 100° C., the solvent and precursors used during the preparation of the catalyst may remain in the catalyst, and thus side reactions may occur. If the calcination temperature is higher than 700° C., particle size is increased due to sintering of the active ingredient, and thus dispersion of the active ingredient such as cobalt is reduced and the specific surface area of the support may be reduced.

In the cobalt/zirconium-phosphorus/silica catalyst, the amount of cobalt may be in the range of 10 to 40 wt% relative to the zirconium-phosphorus/silica support. If the cobalt content is less than 10 wt%, the amount of the active ingredient is not sufficient for the F-T reaction, thus reducing the activity of F-T reaction. On the other hand, if the cobalt content exceeds 40 wt%, the manufacturing cost of the catalyst may increase, and the activity of F-T reaction may be reduced due to the increased particle size of cobalt and the decrease in the specific surface area of the catalyst.

The present invention also provides liquid hydrocarbons prepared from a syngas through F-T reaction in the presence of the catalyst prepared according to the present invention. The F-T reaction may be performed as commonly carried out in the art and is not particularly limited. In the present invention, the F-T reaction is performed using the catalyst in a fixed bed, a fluidized bed, or a slurry-phase reactor, after reducing the catalyst under hydrogen environment at a temperature ranging from 200 to 600° C. The F-T reaction is performed using the reduced catalyst for the F-T reaction in a standard condition, specifically at a temperature of 200 to 300° C. at a pressure of 5 to 30 kg/cm² at a space velocity of 500 to 10000 h⁻¹, but is not limited thereto.

In the presence of the catalyst prepared according to the method described above, CO conversion during F-T reaction performed at 220° C., at 20 atm, and at space velocity of 2000 h⁻¹ is in the range of 45 to 85 carbon mol%, and the yield of hydrocarbons (C₅ or more), particularly, naphtha, diesel, middle distillate, heavy oil, wax, etc., is in the range of 25 to 75 carbon mol%.

The present invention will now be described in greater detail with reference to the following examples. The following examples are for illustrative purposes only and are not intended to limit the scope of the invention.

### Example 1

Porous silica used as a support was subjected to calcination at 500° C. for 4 hours to remove impurities and water from pores. 5 g of the above pre-treated silica was mixed with a solution prepared by dissolving 1.465 g of zirconium oxynitrate (ZrO(NO₃)₂.xH₂O) and 0.0186 g of phosphoric acid (H₃PO₄) in 60 mL of water to prepare a silica on which zirconium-phosphorus to be impregnated. The zirconium-phosphorus-supported silica was subjected to calcination at 500° C. for 5 hours to prepare a powdery zirconium-phosphorus/silica support.

3 g of the powdery zirconium-phosphorus/silica support was mixed with a cobalt precursor solution prepared by dissolving 3.055 g of cobalt nitrate (Co(NO₃)₂.6H₂O) in 60 mL of deionized water, and the mixture was stirred at room temperature for 12 hours or more. Then, the resultant was dried at 105° C. for 12 hours or more to prepare a powdery cobalt/zirconium-phosphorus/silica catalyst.

3 g of the powder cobalt/zirconium-phosphorus/silica catalyst was mixed with a solution prepared by dissolving 0.0468 g of ruthenium nitrosyl nitrate (Ru(NO)(NO₃)₃) in 60 mL of deionized water, and the mixture was stirred at room temperature for 12 hours or more. Then, the resultant was dried at 105° C. for 12 hours or more and subjected to calcination at 400° C. for 5 hours under air atmosphere to prepare a ruthenium/cobalt/zirconium-phosphorus/silica catalyst. In this regard, the composition of Ru/Co/Zr-P/SiO₂ was 0.5 wt%Ru/20 wt%Co/9.9 wt%Zr-0.1 wt%P/SiO₂[Zr/P=99] based on the weight of the metal. The catalyst has a specific surface area of 219 m²/g, an average pore volume of 0.67 cm³/g, and an average pore size of 10.6 nm.

0.3 g of the prepared catalyst was placed in a ½-inch stainless steel fixed bed reactor and reduced for 12 hours under hydrogen atmosphere (H₂/He at a 5 volume %) at 400° C. before conducting reaction. Then, F-T reaction was performed by supplying the reactants of carbon monoxide, hydrogen, carbon dioxide, and argon (internal standard) to the reactor at a fixed molar ratio of 28.4:57.3:9.3:5 under the following reaction condition [reaction temperature=220° C., reaction pressure=20 kg/cm³, and space velocity=2000 L/kgcat/hr/]. The catalyst performance was measured by using the finished catalyst and is summarized in Table 1. The steady-state condition was obtained after around 60 h reaction and the averaged values for 10 h at the steady-state were taken.

### Example 2

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/9.5 wt%Zr-0.5 wt%P/SiO₂[Zr/P=19] based on the weight of the metal. The catalyst has a specific surface area of 232 m²/g.

F-T reaction was performed under the same conditions as in Example 1, and the steady-state condition was obtained after around 60 h reaction and the averaged values for 10 h at the steady-state were taken and is shown in Table 1.

### Example 3

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/9.0 wt%Zr-1.0 wt%P/SiO₂[Zr/P=9] based on the weight of the metal. The catalyst has a specific surface area of 231 m²/g.

F-T reaction was performed under the same conditions as in Example 1, and the steady-state condition was obtained after around 60 h reaction and the averaged values for 10 h at the steady-state were taken and is shown in Table 1.

### Example 4

A catalyst was prepared in the same manner as in Example 1, except that zirconium oxynitrate (ZrO(NO₃)₂.xH₂O), phosphoric acid (H₃PO₄), and cobalt nitrate (Co(NO₃)₂. 6H₂O) were used as metal precursors. The composition of Co/Zr-P/SiO₂ was 20 wt%Co/9.9 wt%Zr-0.1 wt%P/SiO₂[Zr/P=99] based on the weight of the metal. The catalyst has a specific surface area of 206 m²/g.

F-T reaction was performed under the same conditions as in Example 1, and the steady-state condition was obtained after around 60 h reaction and the averaged values for 10 h at the steady-state were taken and is shown in Table 1.

### Example 5

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/5.0 wt%Zr-1.0 wt%P/SiO₂[Zr/P=5] based on the weight of the metal. The catalyst has a specific surface area of 245 m2/g.

F-T reaction was performed under the same conditions as in Example 1, and the steady-state condition was obtained after around 60 h reaction and the averaged values for 10 h at the steady-state were taken and is shown in Table 1.

### Example 6

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/4.8 wt%Zr-0.2 wt%P/SiO₂[Zr/P=24] based on the weight of the metal. The catalyst has a specific surface area of 240 m²/g.

F-T reaction was performed under the same conditions as in Example 1, and the steady-state condition was obtained after around 60 h reaction and the averaged values for 10 h at the steady-state were taken and is shown in Table 1.

### Example 7

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/9.9 wt%Zr-0.1 wt%P/SiO₂[Zr/P=99] based on the weight of the metal. The catalyst has a specific surface area of 219 m²/g.

F-T reaction was performed under the same conditions as in Example 1, except that the temperature was 240° C., and the steady-state condition was obtained after around 60 h reaction and the averaged values for 10 h at the steady-state were taken and is shown in Table 1.

### Example 8

A catalyst was prepared in the same manner as in Example 4, except that zirconium oxynitrate (ZrO(NO₃)₂.xH₂O), phosphoric acid (H₃PO₄), and cobalt nitrate (Co(NO₃)₂.6H₂O) were used as metal precursors. The composition of Co/Zr-P-SiO₂ was 20 wt%Co/9.9 wt%Zr-0.1 wt%P/SiO₂[Zr/P=99] based on the weight of the metal. The catalyst has a specific surface area of 206 m²/g.

F-T reaction was performed under the same conditions as in Example 1, except that the temperature was 240° C., and the steady-state condition was obtained after around 60 h reaction and the averaged values for 10 h at the steady-state were taken and is shown in Table 1.

### Example 9

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/19.8 wt%Zr-0.2 wt%P/SiO₂[Zr/P=99] based on the weight of the metal. The catalyst has a specific surface area of 215 m²/g.

F-T reaction was performed under the same conditions as in Example 1, and the steady-state condition was obtained after around 60 h reaction and the averaged values for 10 h at the steady-state were taken and is shown in Table 1.

[symbol]

### Example 10

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/28.5 wt%Zr-1.5 wt%P/SiO₂[Zr/P=19] based on the weight of the metal. The catalyst has a specific surface area of 215 m²/g.

F-T reaction was performed under the same conditions as in Example 1, and the steady-state condition was obtained after around 60 h reaction and the averaged values for 10 h at the steady-state were taken and is shown in Table 1.

### Example 11

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/1.9 wt%Zr-0.1 wt%P/SiO₂[Zr/P=19] based on the weight of the metal. The catalyst has a specific surface area of 224 m²/g.

F-T reaction was performed under the same conditions as in Example 1, and the steady-state condition was obtained after around 60 h reaction and the averaged values for 10 h at the steady-state were taken and is shown in Table 1.

### Example 12

A catalyst was prepared in the same manner as in Example 2, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/9.5 wt%Zr-0.5 wt%P/SiO_{2 [Zr/P=}19] based on the weight of the metal. The catalyst has a specific surface area of 232 m²/g.

5.0 g of the catalyst was reduced at 400° C. for 12 hours under hydrogen atmosphere (H₂/He at a volume ratio of 5) and transferred to a slurry reactor under airless condition before conducting reaction. Then, F-T reaction was performed in the same manner as Example 2, by supplying the reactants of carbon monoxide, hydrogen, carbon dioxide, and argon (internal standard) to the slurry reactor at a fixed molar ratio of 28.4:57.3:9.3:5 under the following reaction condition [reaction temperature=220° C. reaction pressure=20 kg/cm², and space velocity=2000 L/kgcat/hr], except that 300 ml of squalane was used as a solvent and 5.0 g of the reduced catalyst was used. The steady-state condition was obtained after around 60 h reaction and the averaged values for 10 h at the steady-state were taken and is shown in Table 1.

### Comparative Example 1

A catalyst was prepared in the same manner as in Example 1, except that zirconium oxynitrate (ZrO(NO₃)₂.xH₂O), cobalt nitrate (Co(NO₃)₂.6H₂O), and ruthenium nitrosyl nitrate (Ru(NO)(NO₃)₃) were used as metal precursors. The composition of Ru-Co/Zr-P/SiO₂ was 0.5 wt%Ru/20 wt%Co/10 wt%Zr/SiO₂ based on the weight of the metal. The catalyst has a specific surface area of 217 m²/g, an average pore volume of 0.65 cm³/g, and an average pore size of 10.6 nm.

0.3 g of the prepared catalyst was placed in a ½-inch stainless steel fixed bed reactor and reduced at 400° C. for 12 hours under hydrogen atmosphere (H₂/He at a 5 volume %) before conducting a reaction. Then, F-T reaction was performed by supplying the reactants of carbon monoxide, hydrogen, carbon dioxide, and argon (internal standard) to the reactor at a fixed molar ratio of 28.4:57.3:9.3:5 under the following reaction condition [reaction temperature=220° C., reaction pressure=20 kg/cm³, and space velocity=2000 L/kgcat/hr]. The steady-state condition was obtained after around 60 h reaction and the averaged values for 10 h at the steady-state were taken and is shown in Table 1.

### Comparative Example 2

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0. 5 wt%Ru/20 wt%Co/8.0 wt%Zr-2.0 wt%P/SiO₂[Zr/P=4] based on the weight of the metal. The catalyst has a specific surface area of 225 m²/g.

F-T reaction was performed under the same conditions as in Example 1, and the steady-state condition was obtained after around 60 h reaction and the averaged values for 10 h at the steady-state were taken and is shown in Table 1.

### Comparative Example 3

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/7.0 wt%Zr-3.0 wt%P/SiO₂[Zr/P=2.3] based on the weight of the metal. The catalyst has a specific surface area of 221 m²/g.

F-T reaction was performed under the same conditions as in Example 1, and the steady-state condition was obtained after around 60 h reaction and the averaged values for 10 h at the steady-state were taken and is shown in Table 1.

### Comparative Example 4

A catalyst was prepared in the same manner as in Example 1, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/5.0 wt%Zr-5.0 wt%P/SiO₂[Zr/P=1] based on the weight of the metal. The catalyst has a specific surface area of 218 m²/g.

F-T reaction was performed under the same conditions as in Example 1, and the steady-state condition was obtained after around 60 h reaction and the averaged values for 10 h at the steady-state were taken and is shown in Table 1.

### Comparative Example 5

A catalyst was prepared in the same manner as in Example 2, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/0.95 wt%Zr-0.05 wt%P/SiO₂[Zr/P=19] based on the weight of the metal. The catalyst has a specific surface area of 258 m²/g.

F-T reaction was performed under the same conditions as in Example 1, and the steady-state condition was obtained after around 60 h reaction and the averaged values for 10 h at the steady-state were taken and is shown in Table 1.

### Comparative Example 6

A catalyst was prepared in the same manner as in Example 2, except that zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/SiO₂ was 0.5 wt%Ru/20 wt%Co/38.0 wt%Zr-2.0 wt%P/SiO₂[Zr/P=19] based on the weight of the metal. The catalyst has a specific surface area of 182 m²/g.

F-T reaction was performed under the same conditions as in Example 1, and the steady-state condition was obtained after around 60 h reaction and the averaged values for 10 h at the steady-state were taken and is shown in Table 1.

### Comparative Example 7

A catalyst was prepared in the same manner as in Example 2, except that Al₂O₃ (Catapal B) having a specific surface area of 200 m²/g was used as a support, and zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/Al₂O₃ was 0.5 wt%Ru/20 wt%Co/9.50 wt%Zr-0.50 wt%P/Al₂O₃ (Catapal B) [Zr/P=19] based on the weight of the metal. The catalyst has a specific surface area of 147 m²/g, an average pore volume of 0.29 cm³/g, and an average pore size of 7.7 nm.

F-T reaction was performed under the same conditions as in Example 1, and the steady-state condition was obtained after around 60 h reaction and the averaged values for 10 h at the steady-state were taken and is shown in Table 1.

### Comparative Example 8

A catalyst was prepared in the same manner as in Example 2, except that TiO₂ having a specific surface area of 80 m²/g was used as a support, and zirconium oxynitrate (ZrO(NO₃)₂.xH₂O), phosphoric acid (H₃PO₄), cobalt nitrate (Co(NO₃)₂.6H₂O), and ruthenium nitrosyl nitrate (Ru(NO)(NO₃)₃) were used as metal precursors. The composition of Ru/Co/Zr-P/TiO₂ was 0.5 wt%Ru/20 wt%Co/9.50 wt%Zr-0.50 wt%P/TiO₂[Zr/P=19] based on the weight of the metal. The catalyst has a specific surface area of 52 m²/g, an average pore volume of 0.23 cm³/g, and an average pore size of 19.5 nm.

F-T reaction was performed under the same conditions as in Example 1, except that the temperature was 240° C., and the steady-state condition was obtained after around 60 h reaction and the averaged values for 10 h at the steady-state were taken and is shown in Table 1.

TABLE 1

| | | | | Carbon | Yield of |
|---|---|---|---|---|---|
| | | | CO con- | selectivity | hydro- |
| | Zr/P | | version | C₁/C₂ to C₄/C₅ | carbons |
| | (weight | Zr-P | (carbon | or more | C₅ or more |
| | ratio) | weight % | mol%) | (carbon mol %) | (%) |
| Example 1 | 99 | 10 | 80.5 | 6.4/8.7/84.9 | 68.3 |
| Example 2 | 19 | 10 | 85.3 | 4.9/7.2/87.9 | 75.0 |
| Example 3 | 9 | 10 | 53.8 | 8.1/12.1/79.8 | 42.9 |
| Example 4 | 99 | 10 | 35.7 | 15.4/12.4/72.2 | 25.8 |
| Example 5 | 5 | 6 | 61.0 | 8.8/12.9/78.3 | 47.8 |
| Example 6 | 24 | 5 | 45.3 | 11.3/15.5/73.2 | 33.2 |
| Example 7 | 99 | 10 | 97.3 | 18.1/17.3/64.6 | 62.9 |
| Example 8 | 99 | 10 | 58.0 | 20.0/14.7/65.3 | 37.9 |
| Example 9 | 99 | 20 | 54.2 | 10.4/8.1/81.5 | 44.2 |
| Example 10 | 19 | 30 | 77.2 | 6.0/6.9/87.1 | 67.2 |
| Example 11 | 19 | 2 | 55.9 | 8.8/7.8/83.4 | 46.6 |
| Example 12 | 19 | 10 | 46.1 | 2.5/3.4/94.1 | 43.4 |
| Comparative | — | — | 32.8 | 22.9/21.9/55.2 | 18.1 |
| Example 1 | | | | | |
| Comparative | 4 | 10 | 27.7 | 14.0/10.3/75.7 | 20.1 |
| Example 2 | | | | | |
| Comparative | 2.3 | 10 | 29.5 | 12.9/10.1/77.0 | 22.7 |
| Example 3 | | | | | |
| Comparative | 1 | 10 | 13.3 | 11.0/11.9/77.1 | 10.3 |
| Example 4 | | | | | |
| Comparative | 19 | 1 | 35.0 | 17.5/15.1/67.4 | 23.6 |
| Example 5 | | | | | |
| Comparative | 19 | 40 | 28.4 | 13.7/10.4/75.9 | 21.6 |
| Example 6 | | | | | |
| Comparative | 19 | 10^{a} | 36.8 | 10.0/8.6/81.4 | 29.9 |
| Example 7 | | | | | |
| Comparative | 19 | 10^{b} | 34.5 | 5.8/8.3/85.9 | 29.7 |
| Example 8 | | | | | |

^{a}alumina support (Al₂O₃)
^{b}titania support (TiO₂)

[symbol]

As shown in Table 1, the yield of liquid hydrocarbons (C₅ or more) obtained by using the ruthenium/cobalt/zirconium-phosphorus/silica catalysts prepared according to Examples 1 to 3 and 5 to 12 according to the present invention was greater than that obtained by using the catalysts prepared according to Comparative Examples 1 to 8.

In addition, the yield of liquid hydrocarbons (C₅ or more) was increased by adding ruthenium, as a promoter, to the cobalt/zirconium-phosphorus/silica catalyst prepared according to Examples 1 to 3 according to the present invention when compared with Example 4 to which ruthenium was not added. At 240° C., the increase in the yield of liquid hydrocarbons (C₅ or more) was higher than the increase in selectivity for methane according to Examples 7 and 8.

Although ruthenium was added to the catalysts prepared according to Comparative

Examples 2 to 4, the yield of liquid hydrocarbons (C₅ or more) was decreased since the Zr/P weight ratio was not within the range of 5 to 100. Thus, it can be seen that a desired activity of the catalyst can only be obtained when the Zr/P ratio is within a desired range that Zr and P are used to treat the surface of silica properly.

Furthermore, the desired activity of the catalyst was not obtained in Comparative

Examples 5 to 6 since the weight % of zirconium-phosphorus/silica was not within the range of 2 to 30.

In Comparative Examples 7 and 8, the alumina support and the titania support were used instead of the silica support for the ruthenium/cobalt/zirconium-phosphorus/support catalyst. As shown in the results of the Comparative Examples 7 and 8, the activity of F-T reaction was not significantly increased when the pore size is too small on Al₂O₃ or when the specific surface area is too small on TiO₂.

The ruthenium/cobalt/zirconium-phosphorus/silica catalyst prepared according to

Example 12 according to the present invention had excellent activity in the slurry-phase reaction, high selectivity for hydrocarbons (C₅ or more), and slowly deactivated when compared with the fixed bed reactor. For example, it took more than 50 hours for the CO conversion to decrease by 10% in the fixed bed reactor of Example 2, while the CO conversion was maintained at 45% or higher after 100 hours in the slurry reactor of Example 12.

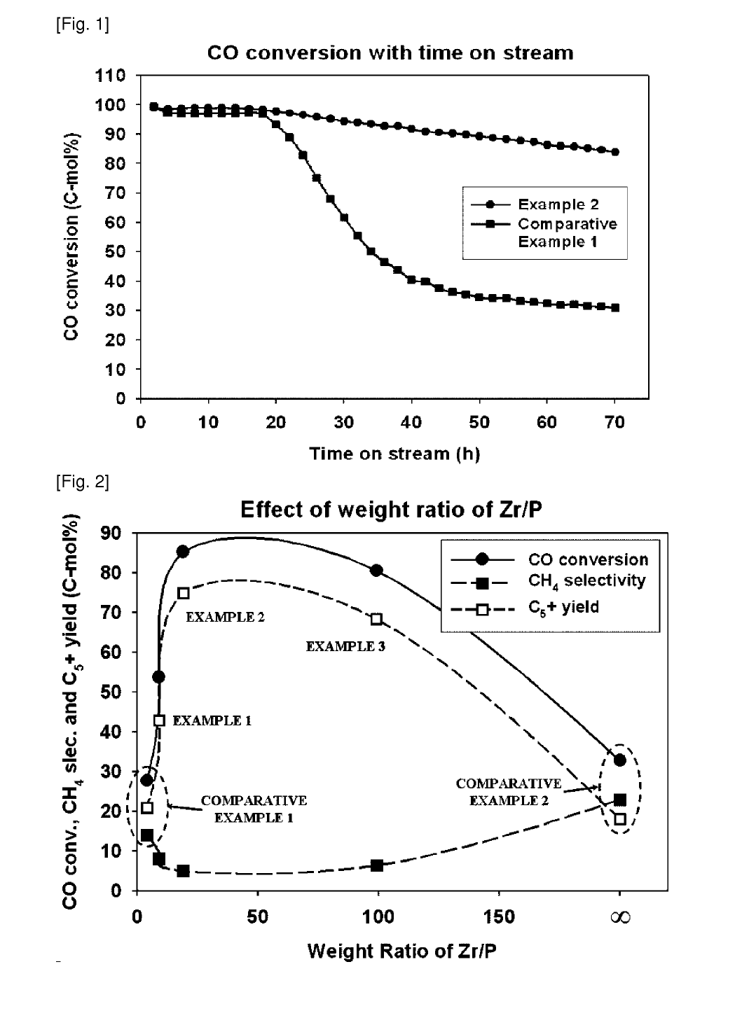

Meanwhile, FIG. 1 illustrates CO conversion with reaction time when F-T reaction is performed using catalysts prepared according to Example 2 and Comparative Example 1. The activity of the F-T reaction was high when the catalyst having a Zr/P weight ratio of 19 prepared according to Example 2 was used. On the contrary, the activity of the F-T reaction was initially high but rapidly decreased after 20 hours when the catalyst without using the phosphorous prepared according to Comparative Example 1 (Zr/P =8) was used. Thus, the deactivation of the catalyst may be inhibited by appropriately controlling the weight ratio of zirconium (Zr) and phosphorus (P). Therefore, a long-term stability of the catalyst may be increased.

FIG. 2 illustrates yield of liquid hydrocarbons, CO conversion, and selectivity for methane with the variation of Zr/P weight ratio contained in a support when F-T reaction is performed using catalysts prepared according to Examples 1 to 3 and Comparative Examples 1 and 2. The activity of the F-T reaction was high when the weight ratio of Zr/P was in the range of 5 to 100. On the contrary, the activity of the F-T reaction was decreased when the weight ratio of Zr/P was less than 5 or phosphorous was not used (Zr/P =8). Therefore, the weight ratio of Zr/P needs to be controlled within a desired range in order to obtain a desired activity of the F-T reaction.

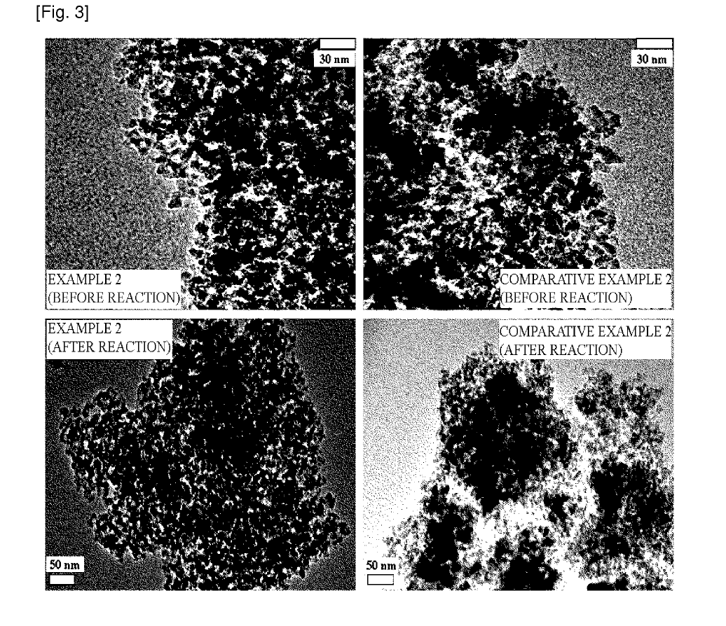

FIG. 3 illustrates transmission electron microscopy (TEM) images of particles of cobalt in catalysts prepared according to Example 2 and Comparative Example 2 before and after F-T reaction.

In the catalyst having stable activity, cobalt particles were hardly sintered before and after the F-T reaction as shown in the TEM images of Example 2. On the contrary, cobalt particles after the F-T reaction in the catalyst, which was stabilized after the activity, was significantly increased as shown in the TEM images of Comparative Example 2.

It will be apparent to those skilled in the art that various modifications and variations can be made in the present invention without departing from the spirit or scope of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims. Industrial Applicability

In the development of the GTL technology, which is gaining attention as a solution to the abrupt increase of oil price of recent times, the improvement of the catalyst for the F-T synthesis is directly associated with the development of the competitiveness of the GTL technology. In particular, the improvement of the catalyst for the F-T reaction enables the improvement of thermal efficiency and carbon efficiency in the GTL process, and the systematic design of the F-T reaction process can be optimized. Thus, a competitive GTL process having low selectivity for methane and stable production of liquid hydrocarbons (C₅ or more) can be developed by preparing a catalyst for F-T reaction having high CO conversion, stable production of liquid hydrocarbons, and reduced deactivation using a silica support treated with zirconium and phosphorus.

1. A cobalt/zirconium-phosphorus/silica catalyst for Fischer-Tropsch reaction in which cobalt, as an active ingredient, is impregnated on a support,
wherein the support is a zirconium-phosphorus/silica support in which zirconium (Zr) and phosphorus (P) are simultaneously contained on the surface of porous silica having a specific surface area of 200 to 800 m²/g,
wherein the amount of zirconium-phosphorus is in the range of 2 to 30 wt% relative to the silica, the amount of zirconium is in the range of 5 to 100 wt% relative to phosphorus, and the amount of cobalt (Co) is in the range of 10 to 40 wt% relative to the zirconium-phosphorus/silica support.

2. The cobalt/zirconium-phosphorus/silica catalyst of claim 1, further comprising 0.05 to 2 wt% of a catalyst promoter selected from the group consisting of Ru, Pt, and Rh, relative to the cobalt/zirconium-phosphorus/silica catalyst.

3. The cobalt/zirconium-phosphorus/silica catalyst of claim 1, having a specific surface area of 190 to 300 m²/g.

4. A method of preparing a cobalt/zirconium-phosphorus/silica catalyst for Fischer-Tropsch reaction, the method comprising:
preparing a zirconium (Zr)-phosphorus (P)/silica support by simultaneously containing a zirconium precursor and a phosphorus precursor on porous silica having a specific surface area of 200 to 800 m²/g, drying at a temperature of 100 to 200° C., and calcining at a temperature of 300 to 800° C.; and
preparing a cobalt/zirconium-phosphorus/silica catalyst by supporting a cobalt precursor on the zirconium-phosphorus/silica support, drying at a temperature of 100 to 200° C., and calcining at a temperature of 100 to 700° C.

5. The method of claim 4, wherein the supporting process is performed by impregnation or co-precipitation method.

6. The method of claim 5, wherein the co-precipitation is performed using a basic precipitant, selected from the group consisting of sodium carbonate, potassium carbonate, ammonium carbonate, and ammonia water, so as to maintain the pH in the range of 7 to 8.

7. The method of claim 4, wherein the zirconium precursor is a single compound selected from the group consisting of zirconium oxynitrate (ZrO(NO₃)₂.xH₂O), zirconium oxychloride (ZrOCl₂.xH₂O), zirconium sulfate (Zr(SO₄)₂), and zirconium chloride (ZrCl₄), or a mixture of at least two of these compounds.

8. The method of claim 4, wherein the phosphorus precursor is a single compound selected from the group consisting of phosphoric acid (H₃PO₄), phosphorus oxychloride (POCl₃), phosphorus pentaoxide (P₂O₅), and phosphorus trichloride (PCl₃), or a mixture of at least two of these compounds.

9. The method of claim 4, wherein the amount of zirconium-phosphorus is in the range of 2 to 30 wt% relative to silica.

10. The method of claim 4, wherein the amount of zirconium is in the range of 5 to 100 wt% relative to phosphorus.

11. The method of claim 4, wherein the cobalt precursor is a single compound selected from the group consisting of nitrate, acetate, and chloride, or a mixture of at least two of these compounds.

12. The method of clam 4, wherein the amount of cobalt is in the range of 10 to 40 wt% relative to the zirconium-phosphorus/silica support.
